(19) United States
(12) Patent Application Publication
(10) Pub. No.: US 2024/0389781 A1
(43) Pub. Date: Nov. 28, 2024

(54) Thread fixing base and quick fixing structure

(71) Applicant: Sincere Greenworld Corporation, LOS ANGELES, CA (US)

(72) Inventors: Wei CHEN, Shanghai (CN); Jinhao ZHANG, Shanghai (CN)

(73) Assignee: Sincere Greenworld Corporation, LOS ANGELES, CA (US)

(21) Appl. No.: 18/323,367

(22) Filed: May 24, 2023

(51) Int. Cl. E04H 12/22; A47G 33/12

(52) U.S. Cl. CPC A47G 33/12; E04H 12/2238; E04H 12/2269; F16B 37/0821; F16B 37/0885; F16B 37/0892

(57) ABSTRACT

A thread fixing base and a quick fixing structure, wherein the thread fixing base is used in conjunction with a thread rod. The thread fixing base comprises a base and a top cover, wherein the base has a thread groove, and is provided with a hinge base on one side thereof, and is provided with a buckle groove on the other side thereof. The top cover has a limit top plate that is pressed against the thread ring surface of the thread rod and extends axially along the thread ring surface. On one side of the limit top plate, the top cover is provided with a shaft component that is hinged and matched with the hinge base. On the other side of the limit top plate, the base is provided with a buckle plate that is locked with the buckle groove.

### TECHNICAL FIELD

The invention relates to the technical field of fixing devices, particularly a thread fixing base and a quick fixing structure.

### BACKGROUND ART

The most commonly used fixing method is to use multiple bolt ends to tighten the components to be fixed. To enhance the fixation strength, the bolt end is generally long, so it takes a long time to rotate the thread when fixing or loosening the component to be fixed, resulting in low installation efficiency.

For example, the Christmas tree base on the market is equipped with a thread clamping device to fix the tree trunk, and four long screws are used to clamp the Christmas tree trunk by rotating and tightening. But fixing or loosening the Christmas tree is time-consuming and labor-intensive, and it takes a long time to rotate the screw.

Therefore, the applicant discloses a thread fitting component and a quick fixing structure (application number CN2020201243961). The quick fixing structure comprises a first fitting part, a second fitting part and a thread part, wherein the first fitting part comprises a first non-complete thread groove. The second fitting part and the first fitting part can be unlocked and locked, and a second non-complete thread groove is also comprised. The first non-complete thread groove and the second non-complete thread groove form a complete screw hole when the second fitting part and the first fitting part are locked. The coordinated movement of thread parts and thread fitting components can quickly tighten and disassemble the object to be fixed. On the basis of ensuring fixing strength, the quick fixing structure reduces installation time, but the following shortcomings still exist:

In order to be used, the thread part needs to be threaded together with the first and second non-complete thread grooves. Therefore, high accuracy is required for the thread fitting of the first non-complete thread groove, second non-complete thread groove and thread parts, resulting in high manufacturing costs. Meanwhile, due to the fact that the first fitting part is assembled on the base, assembly requires much time. The first fitting part and the second fitting part are used for upper and lower buckling or fixing bolts are used for connection or push-pull parts and grooves mutually fit to lock. This type of structure features a long assembly time and inconvenient unlocking and locking.

### Content of Invention

In view of above, the invention provides an optimized structure for thread fixing base and quick fixing structure which has less strict requirements for thread assembly accuracy, while improving the convenience of assembly, unlocking and locking of the thread fixing base.

To achieve the above objectives, the invention adopts the following technical solution:
a thread fixing base which is used in conjunction with a thread rod and comprises a base and a top cover, wherein the base has a thread groove, and is provided with a hinge base on one side of the thread groove, and is provided with a buckle groove on the other side of the thread groove. The top cover has a limit top plate that is pressed against the thread ring surface of the thread rod and extends axially along the thread ring surface. On one side of the limit top plate, the top cover is provided with a shaft component that is hinged and matched with the hinge base. On the other side of the limit top plate, the base is provided with a buckle plate that is locked with the buckle groove.

Wherein, the hinge base and the shaft component are hinged to make one side of the top cover and one side of the base rotatable to fit; the buckle plate and the buckle groove are buckled to make the other side of the top cover and the other side of the base able to be unlocked and locked. When the top cover and the base are locked, the thread groove and the limit top plate jointly form a screw hole that matches the thread rod. When the top cover and the base are unlocked, and the thread groove and the limit top plate are far away from each other, the thread rod can be taken out of the thread groove or placed inside the thread groove.

To better achieve the above technical solution, optionally, the cross section of the thread groove is semi-circular.

Optionally, the hinge base comprises a pair of hinge side ears fixing at both ends on one side of the base, and the opposite side walls of the pair of hinge side ears are provided with coaxial hinge holes; the shaft component comprises a rotating part fixing on one side of the top cover, and opposite sides of the rotating part are respectively provided with shaft holes. Each shaft hole can be equipped with a hinge shaft in a retraction way. The first end of the hinge shaft is connected to the bottom of the shaft hole, and the second end of the hinge shaft is clamped into the hinge hole to connect the hinge side ears with to the shaft component.

Optionally, the end face of the second end of the hinge shaft is an inclined plane.

Optionally, one side of the base set with the buckle groove is also provided with a snap bulge, and the top cover is provided with a snap groove that is in interference fit with the snap bulge.

Optionally, the buckle plate is in an inverted T-shaped structure, the upper vertical part of the buckle plate is fixedly connected with the center of one side of the top cover, the end of the lower transverse part of the buckle plate facing the base is a locking part, the locking part is in interference fit with the buckle groove, and the lower transverse part of the buckle plate is away from the end of the base to form an unlocking part.

Optionally, the top cover is equipped with a plurality of reinforcing plates fixedly connected to the limit top plate.

Optionally, the top cover has a hollow structure inside.

A quick fixing structure comprising a thread fixing base, a thread rod and a base as described in any of the above:

The thread rod and the thread fixing base are arranged in pairs, and the base comprises a fixing wall and a fixing space enclosed by the fixing wall, wherein, the thread fixing base is uniformly fixing on the top circumferential surface of the fixing wall, the thread rod rotates in the screw hole formed by the locking of the base and the top cove, so as to be used to press and tighten the part to be fixed in the fixing space, and the thread rod can move relative to the base in a non-thread way when the base and top cover are unlocked.

To better achieve the above technical solution, optionally, the thread rods are symmetrically distributed around the part to be fixed.

The invention has the following advantages:

The invention provides to a thread fixing base, in which the thread of the thread rod only needs to be matched with the thread in the thread groove. Therefore, the requirement on the thread fitting accuracy of the thread fixing base is low, which is beneficial for reducing manufacturing costs.

The quick fixing structure of the invention makes the assembly of the base and the top cover simpler, and the unlocking and locking of the top cover and base are more convenient.

### FIGURES

FIG. 1 is a three-dimensional schematic diagram of the thread fixing base in embodiment 1 of the invention;

FIG. 2 is a three-dimensional schematic diagram of the base in FIG. 1:

FIG. 3 is a three-dimensional schematic diagram of the top cover in FIG. 1:

FIG. 4 is a three-dimensional schematic diagram of the quick fixing structure in embodiment 2 of the invention;

### MARKINGS IN THE FIGURES

Base 10, thread groove 11, hinge side ear 12, hinge hole 121, buckle groove 13, snap bulge 14, top cover 20, buckle plate 21, upper vertical part 211, locking part 212, unlocking part 213, limit top plate 22, reinforcement plate 23, rotating part 24, hinge shaft 25, inclined section 251, clamp groove 26, thread rod 30, base 40, fixing wall 41, fixing space 42.

### DESCRIPTION OF PREFERRED EMBODIMENTS

The technical solution of the invention is described in detail in conjunction with the figures and specific embodiments. The same components are marked in the same numbers in the figures.

It should be noted that more details are elaborated in the following description for a comprehensive understanding of the invention. However, the invention can obviously be implemented in various other ways that are different from the description. Technicians in the art can make similar promotions and deductions based on practical applications without violating the spirit of the invention. Therefore, the scope of protection of the invention should not be limited by the content of the specific embodiments. It should also be noted that these and other subsequent figures are only examples but are not drawn according to proportional conditions, and should not be used as any limitation on the actual scope of protection required by the invention.

### Embodiment 1

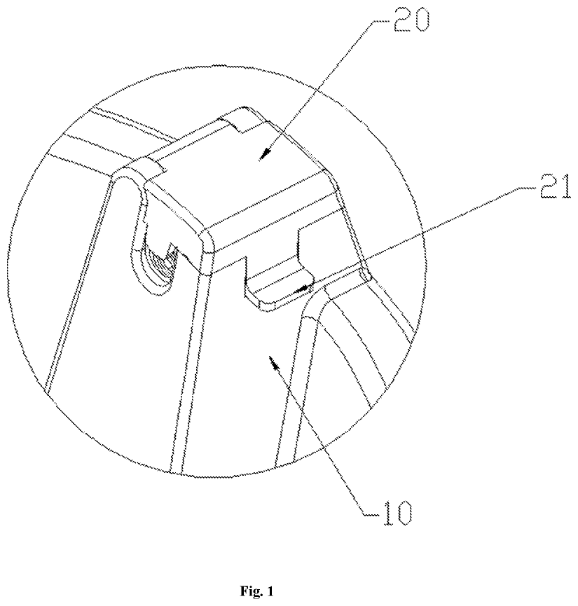

Please refer to FIGS. 1 to 3, the embodiment discloses a thread fixing base, which is used in conjunction with a thread rod, wherein the thread rod is a structural body with an external thread, such as a thread top rod and a bolt.

Specifically, the thread fixing base comprises a base 10 and a top cover 20, wherein, the bottom base 10 has a thread groove 11, and is equipped with a hinge base on one side of the thread groove 11, and a buckle groove 13 on the outer wall of the other side of the thread groove 11. The top cover 20 has a limit top plate 22 that is pressed against the thread ring surface of the thread rod and extends axially along the thread ring surface, and the top cover 20 is equipped with a shaft component that is hinged and matched with the hinge base on one side of the limit top plate 22. On the other side of the limit top plate 22, the bottom base 10 is equipped with a buckle plate 21 that is securely connected and locked with the buckle groove 13:

Wherein, the hinge base and the shaft component are hinged to make one side of the top cover 20 rotatably fit with the side of the bottom base 10, and the buckle plate 21 and buckle groove 13 are interlocked to make the other side of the top cover 20 and the other side of the bottom base 10 unlock and lock. When the top cover 20 is locked with the bottom base 10, the thread groove 11 and the limit top plate 22 jointly form a screw hole that fits with the thread rod. When the top cover 20 is unlocked with the bottom base 10, and the thread groove 11 and the limit top plate 22 are away from each other, the thread rod can be taken out of or placed in the thread groove 11.

More specifically, the cross section of the thread groove 11 is semi-circular, and the cross section of the thread groove 11 can also be an inferior arc with a central angle between 120° and 180°, so as to quickly take out the thread rod from the thread groove 11 and quickly clamp the thread rod into the thread groove 11.

More specifically, when the top cover 20 is locked with the bottom base 10, the thread groove 11 faces the limit top plate 22 up and down.

In the embodiment of the application, the hinge base comprises a pair of hinge side ears 12 fixing at both ends of one side of the bottom base 10, coaxial hinge holes 121 are arranged on the opposite side walls of the hinge side ears 12, the shaft component comprises a rotating part 24 fixing on one side of the top cover 20, and shaft holes are respectively arranged on the opposite sides of the rotating part 24. Each shaft hole is equipped with a hinge shaft 25 in a retraction way, and the first end of the hinge shaft 25 is connected to the bottom of the shaft hole, the second end of the hinge shaft 25 is clamped into the hinge hole 121, allowing the hinge side ear 12 to be movably connected to the shaft component, thereby enabling the top cover 20 to rotate around the hinge shaft 25 as the central axis. The retractable hinge shaft 25 is provided to make it easy for the second end of the hinge shaft 25 to be clamped into the hinge hole 121.

In an embodiment of the application, the end face of the second end of the hinge shaft 25 is an inclined plane 251, which further makes it easy for the second end of the hinge shaft 25 to be clamped into the hinge hole 121. The two opposite side walls of the rotating part 24 are in clearance fit with the two hinge side ears 12, making the rotating part 24 rotate more flexibly relative to the hinge side ears 12.

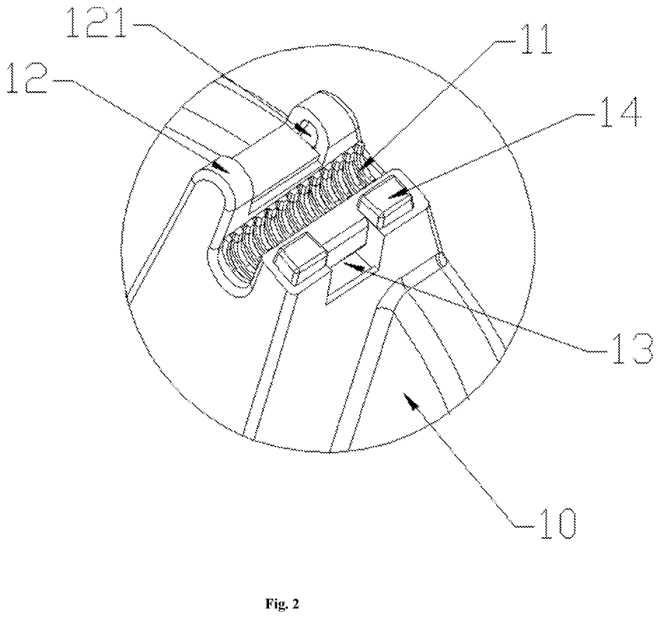

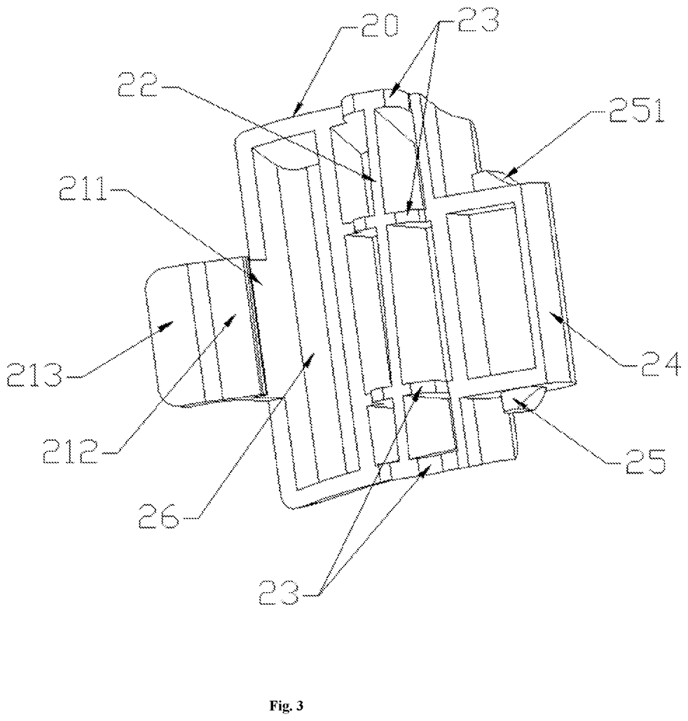

As shown in FIGS. 2 and 3, one side of the bottom base 10, which is provided with the snap groove 13, is also provided with snap bulges 14. Specifically, two snap bulges 14 are located above both sides of the snap groove 13. The snap bulges 14 are in a conical platform structure with the upper end smaller than the lower end. The top cover 20 has a snap groove 26 which is in interference fit with the snap bulges 14. The snap groove 26 can be an integral groove or two independent grooves. The buckle plate 21 can only be buckled with the buckle groove 13 when the snap bulges 14 and the snap groove 26 are connected together. The combination of the buckle bulges 14 and the buckle groove 26 can increase the strength when the bottom base 10 is locked with the top cover 20.

As shown in FIG. 2, the buckle plate 21 is in an inverted T-shaped structure. The upper vertical part 211 of the buckle plate 21 is fixedly connected with the center on one side of the top cover 20. The end of the lower transverse part of the buckle plate 21 facing the bottom base 10 is a locking part 212. The locking part 212 is in interference fit with the buckle groove 13. The lower transverse part of the buckle plate 21 faces away from the end of the bottom base 10 to form a unlocking part 213. The buckle plate 21 and the buckle groove 13 form a horizontal unlocking structure. The snap bulges 14 form a vertical unlocking structure with the clamping groove 26, and the locking part 212 is matched with the clamping groove 13. The snap bulges 14 are matched with the clamping groove 26, making the bottom base 10 more stable when locked with the top cover 20, thereby effectively increasing the strength when the bottom base 10 is locked with the top cover 20.

In the embodiment of the application, the top cover 20 is equipped with a plurality of reinforcing plates 23 fixedly connected to the limit top plate 22, and the reinforcing plates 23 are connected to the limit top plate 22 to form a grid structure. The bottom surface of the reinforcing plate 23 is coplanar with the bottom surface of the limit top plate 22. The reinforcing plates 23 reinforce the strength of the limit top plate 22 and jointly limit the thread ring surface of the thread rod with the limit top plate 22.

In an embodiment of the application, the top cover 20 has a hollow structure inside, making the top cover 20 more lightweight so as to save raw materials.

In a thread fixing base according to the embodiment of the application, the top cover 20 and the bottom base 10 are mutually locked and unlocked, making the thread groove 11 and the limit top plate 22 form a screw hole when close to each other, and form an open structure when away from each other. When the thread groove 11 and the limit top plate 22 form a screw hole, the thread rod can be rotated to move axially along the thread groove 11 to tighten the part to be fixed. When the thread groove 11 and the limit top plate 22 are far away from each other to form the open structure, the thread rod can be placed in or taken out from the thread groove 11.

For the thread fixing base of the embodiment of the application, the thread of the thread rod only needs to be threaded in the thread groove 11. Therefore, the requirement on the screw fitting accuracy for the thread fixing base is low, which is beneficial for reducing manufacturing costs.

### Embodiment 2

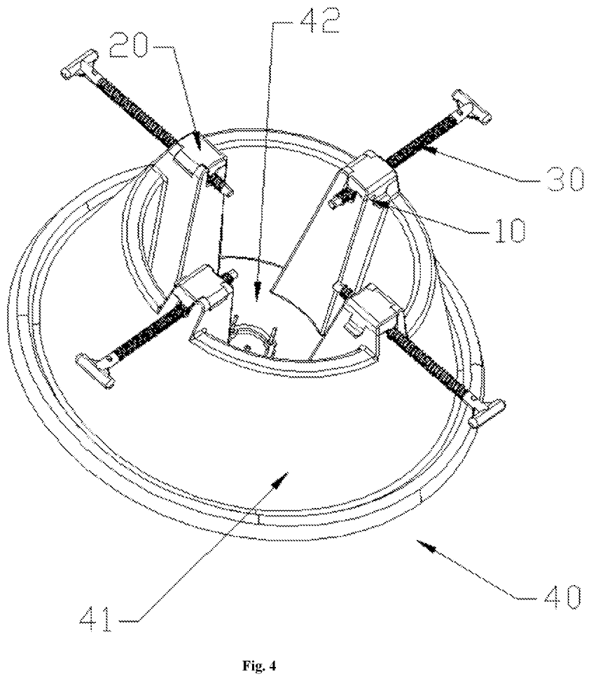

Please refer to FIG. 4, the embodiment discloses a quick fixing structure, which comprises a thread rod 30, a base 4, and a thread fixing base in embodiment 1.

Wherein, the thread rod 30 and the thread fixing base are arranged in pairs, and the base 40 comprises a fixing wall 41 and a fixing space 42 enclosed by the fixing wall 41:

The thread fixing base is uniformly fixing on the top circumferential surface of the fixing wall 41, and the thread rod 30 can rotate in the screw hole formed by the locking of the bottom base 10 and the top cover 20, so as to tighten the part to be fixed in the fixing space 42. The thread rod 30 can move in a non-thread way relative to the base 40 when the bottom base 10 and the top cover 20 are unlocked.

A plurality of thread rods 30 are symmetrically distributed around the part to be fixed, and the number of thread rods 30 and thread fixing bases is at least three, which can be set according to the specification of the fixing part.

The quick fixing structure of the embodiment of the application is similar to that disclosed by the applicant (application number: CN2020201243961), with the difference that in this embodiment, the bottom base 10 and the base 40 are in an integrated structure, facilitating the assembly of the bottom base 10 and the top cover 20.

A method for using the quick fixing structure in the embodiment of the application is as follows (the method of using the tree stump to lock the Christmas tree is taken as an example):

When fixing the stump of the Christmas tree:

Pull the unlocking part 213 to separate the locking part 212 from the buckle groove 13, and then forcefully flip the buckle plate 21 to separate the snap groove 26 from the snap bulge 14, achieving complete unlocking of the top cover 20 and the bottom base 10. At this time, the thread groove 11 and the limit top plate 22 are separated from each other:

Place the thread rod 30 into the thread groove 11 and align the thread in the thread groove 11 with the thread of the thread rod 30. Rotate the top cover 20 in the opposite direction, and engage the snap groove 26 with the snap bulge 14, and then the locking part 212 and the buckle groove 13 are mutually buckled to achieve mutual locking between the top cover 20 and the bottom base 10; Rotate the thread rod 30 to gradually press and tighten the tree stump through the rotation of the thread, so as to tighten and fix the Christmas tree.

When disassembling the quick fixing structure:

Pull the unlocking part 213 to detach the locking part 212 from the buckle groove 13, and forcefully flip the buckle plate 21 to detach the snap groove 26 from the snap bulge 14, achieving complete unlocking of the top cover 20 and the bottom base 10. At this time, the thread groove 11 and the limit top plate 22 are separated from each other, and the thread rod 30 is taken out of the thread groove 11 to keep it away from the tree trunk.

The quick fixing structure of the embodiment of the application makes the assembly of the bottom base 10 and the top cover 20 simpler, and the unlocking and locking of the top cover 20 and the bottom base 10 more convenient.

The above provides a detailed introduction to the technical solution of the invention in conjunction with specific embodiments which are used to help understand the ideas of the invention. The derivation and modification made by technical personnel in this field based on the specific embodiments of the invention should also fall within the scope of protection of the invention.

1. A thread fixing base used in conjunction with a thread rod (30), which is characterized by comprising a bottom base (10) and a top cover (20):
The bottom base (10) has a thread groove (11), and is provided with a hinge base on one side of the thread groove (11) and is provided with a buckle groove (13) on the outer wall of the other side of the thread groove (11);
The top cover (20) is provided with a limit top plate (22) that is pressed against the thread ring surface of the thread rod (30) and extends axially along the thread ring surface. On one side of the limit top plate (22), the top cover (20) is equipped with a shaft component that is hinged and matched with the hinge base. On the other side of the limit top plate (22), the bottom base (10) is equipped with a buckle plate (21) that is locked with the buckle groove (13);
Wherein, the hinge base and the shaft component are hinged to make one side of the top cover (20) and one side of the bottom base (10) rotatably fit, and the buckle plate (21) is buckled with the buckle groove (13) to make the other side of the top cover (20) and the other side of the bottom base (10) unlocked and locked. When the top cover (20) is locked with the bottom base (10), the thread groove (11) and the limit top plate (22) jointly form a screw hole that fits with the thread rod (30). When the top cover (20) and the bottom base (10) are unlocked and the thread groove (11) and the limit top plate (22) are far away from each other, the thread rod (30) can be taken out of the thread groove (11) or placed inside the thread groove (11).

2. A thread fixing base according to claim 1, which is characterized in that the cross section of the thread groove (11) is semi-circular.

3. A thread fixing base according to claim 1, which is characterized as follows:
the hinge base comprises a pair of hinge side ears (12) fixing at both ends of one side of the bottom base (10), and the opposite side walls of the pair of hinge side ears (12) are provided with coaxial hinge holes (121);
the shaft component comprises a rotating part (24) fixing on one side of the top cover (20), and the opposite sides of the rotating part (24) are respectively provided with shaft holes. Each shaft hole is equipped with a hinge shaft (25) in a retraction way, and the first end of the hinge shaft (25) is connected to the bottom of the shaft hole. The second end of the hinge shaft (25) is clamped into the hinge hole (121) to connect the hinge side ear (12) with the shaft component.

4. A thread fixing base according to claim 3, which is characterized in that the end face of the second end of the hinge shaft (25) is an inclined plane (251).

5. The thread fixing base according to claim 4, which is characterized in that one side of the bottom base (10) with the buckle groove (13) is also provided with snap bulges (14), and the top cover (20) is provided with a clamp groove (26) that is in interference fit with the snap bulges (14).

6. The thread fixing base according to claim 5, which is characterized in that the buckle plate (21) is in an inverted T-shaped structure, the upper vertical part (211) of the buckle plate (21) is fixedly connected with the center of one side of the top cover (20), the end of the lower transverse part of the buckle plate (21) facing the bottom base (10) is a locking part (212), and the locking part (212) is in interference fit with the buckle groove (13), and the lower transverse part of the buckle plate (21) is deviated from the end of the bottom base (10) to form an unlocking part (213).

7. A thread fixing base according to claim 1, which is characterized in that the top cover (20) is provided with a plurality of reinforcing plates (23) fixedly connected to the limit top plate (22).

8. A thread fixing base according to claim 7, which is characterized in that the top cover (20) has a hollow structure inside.

9. A quick fixing structure, which is characterized by comprising:
a thread fixing base according to claim 1;
a thread rod (30) arranged in pairs with a thread fixing base;
and a base (40), which comprises a fixing wall (41) and a fixing space (42) enclosed by the fixing wall (41);
wherein, the thread fixing base is uniformly fixing on the top circumferential surface of the fixing wall (41), and the thread rod (30) can rotate in the screw hole formed by the locking of the bottom base (10) and the top cover (20), so as to tighten the part to be fixed in the fixing space (42). The thread rod (30) can move in a non-thread way relative to the base (40) when the bottom base (10) and the top cover (20) are unlocked.

10. A quick fixing structure according to claim 9, which is characterized in that a plurality of thread rods (30) are symmetrically distributed around the part to be fixed.
